(19) United States
(12) Patent Application Publication
(10) Pub. No.: US 2026/0061566 A1
(43) Pub. Date: Mar. 5, 2026

(54) CLAMP MOUNT

(71) Applicant: Components Express, LLC, Woodridge, IL (US)

(72) Inventors: Nick DeFrancesco, Morris, IL (US); Bryan Pukowski, Chicago, IL (US)

(73) Assignee: Components Express, LLC, Woodridge, IL (US)

(21) Appl. No.: 18/909,052

(22) Filed: Oct. 8, 2024

Related U.S. Application Data
(60) Provisional application No. 63/689,598, filed on Aug. 30, 2024.

(51) Int. Cl. B25B 5/16; B25B 5/02

(52) U.S. Cl. CPC B25B 5/166; B25B 5/02

(57) ABSTRACT

A clamp mount for clamping directly to T-slot tubing is disclosed. The clamp mount has a sizing surface suitable for assisting an installer to select a specific size of T-slot tubing. The clamp mount also has a mounting surface configurable by the purchaser to be suitable for a variety of pre-existing mounts. attached to or clamped to or mounted to T-slot tubing. During installation, the sizing surface can be used first, when someone is first attaching the clamp mount to the T-slot tubing. After that sizing is set, the user will typically only then attach the mount to the mounting surface. However, this could also be done in the reverse order.

### BACKGROUND OF THE INVENTION

T-slot tubing is typically made from extruded aluminum rails and is sold in numerous sizes as shown in FIGS. 10-11 (Prior Art). Numerous customers use specialized mounts such as shown in FIGS. 9A and 13 (Prior Art) for mounting various devices, including but not limited to machine vision cameras. However, it is difficult to attach such specialized mounts to T-slot tubing, which can be an important component in industrial arrangements\configurations.

To address these and other problems, a customized and further-customizable clamp mount is desired.

### SUMMARY OF THE EMBODIMENTS

A potential customer would be someone who has an industrial infrastructure using T-slot tubing in which mounting must be achieved, e.g. machine-vision infrastructures. Such infrastructures may have varying sizes of T slot tubing.

Customers have numerous implementations of T-slot having varying sizes. The embodiments herein accommodate multiple sizes of T-slot, thus being versatile, again, using a “one-size-fits-many” principles.

T-slot tubing is versatile, flexible, and has low cost. However, one disadvantage is attachment/detachment. In mounting any product on to the T-slots it is necessary to take apart whatever structure, slide various nuts or other threaded items inside the slots through the end-only, almost never installable in the middle, and then arrange them into position. Then and only then, re-attach the end-caps and restore the T-slot mechanisms back into the industrial arrangement\configuration.

A small exception does exist. T-slot tubing also accommodates threaded items that drop in without detachment of end-pieces. These pieces are more expensive, and a user can hold them in place and only then attach an item. They also work their way loose much more often.

Meanwhile, in sharp contrast, the embodiments herein permit going directly to whatever tubing or rail including arrangement\configurations that are already preassembled, as long as access to three sides of the T-slot square exists. A worker can quickly attach the embodiments herein anywhere they see fit without need to remove any end cap pieces.

### BRIEF DESCRIPTION OF DRAWINGS

FIGS. 1A-1B show an example clamp mount;

FIGS. 2A-2B show example configurations of a sizing surface;

FIGS. 3 and 5 show an example clamp mount clamped onto a section of T-slot rail including free-floating threaded pins;

FIG. 4 shows example springs within a clamp mount;

FIG. 6 shows more detail of the clamp mount including guide posts;

FIG. 7 shows potential threaded mount holes;

FIG. 8 shows an example movement of the clamp mount along a lateral axis;

FIG. 9A shows a Prior Art mount, and FIG. 9B shows that same Prior Art mount mounted onto an example clamp mount;

FIGS. 10-11 show example embodiments of Prior Art T-slot tubing;

FIG. 12 shows the clamp mount attached to a conventional table-surface;

FIG. 13 shows example Prior Art mounts; and

FIG. 14 shows a Prior Art mount attached to a clamp mount.

### DETAILED DESCRIPTION OF PREFERRED EMBODIMENTS

### Semantics

A clamp mount is the main focus of the embodiments herein. However, the expression “clamp mount” has embedded meanings

for which clarification can be helpful. First, the words “mount” and “clamp” can be both a noun and a verb, and this disclosure contains both usages. Second, the embodiments herein can be clamped to various surfaces, but this could also be described as being “mounted” to those various surfaces.

Thus, it might be more accurate to describe the embodiments herein as “a customized clamp, upon which a variety of mounts can be attached”. Knowing this language would be cumbersome and overly detailed, a more convenient expression “clamp mount” will be used herein, and will have the element number 100.

Next, within the various drawings herein, 1.5″ square T-slot will be assumed, although the embodiments herein should not be limited exclusively thereto and could for example by 30 mm square or 45 mm square T-slot tubing.

Finally, the embodiments herein have both a mounting surface and a sizing surface. These are not the same, although they are both located within the mated plate 109 big. They are perpendicular to each other.

During installation, the sizing surface comes first, when someone is first attaching the clamp mount to the T-slot tubing. After that sizing is set, the user will typically only then attach the mount to the mounting surface of the clamp mount. However, this could also be done in the reverse order.

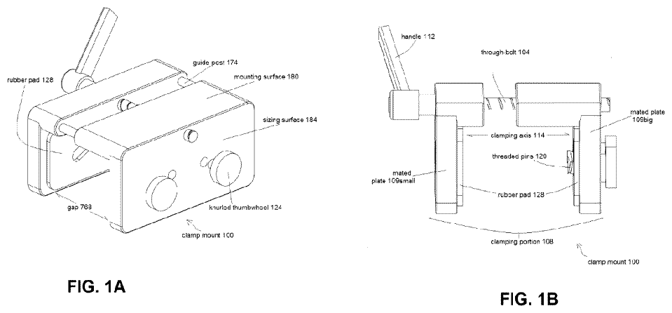

FIGS. 1A-1B show an example clamp mount 100, in which a clamp portion 108 is opened and closed along a clamping axis 114 using a through-bolt 104 having a handle 112.

The clamp portion 108 comprises two mated clamping plates 109 big and 109 small. The clamp portion 109 big contains two or more threaded holes 154 for accommodating the threaded pins 120 (shown in the format of protruding screws). The threaded pins 120 are operated by a user via the knurled thumbwheels 124. The two mated clamping plates 109 big and 109 small move only along the clamping axis 114.

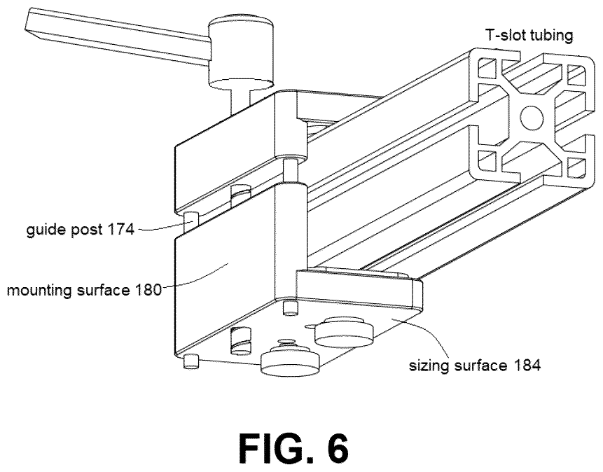

Various Figures herein e.g. FIG. 6 show the guide posts 174 parallel to the clamping axis 114. The guide posts 174 provide stability and ensure the mated plates 109 big and 109 small properly travel along the clamping axis 114.

The clamp portion 108 is for clamping or gripping onto the T-slot rail. The threaded pins 120 act as a secondary retention source to assist the clamping force of the clamp portion 108.

FIG. 1B shows a set of rubber pads 128 for gripping onto the T-slot or rail, thereby providing additional security to not fly off or come loose from the T-slot or rail.

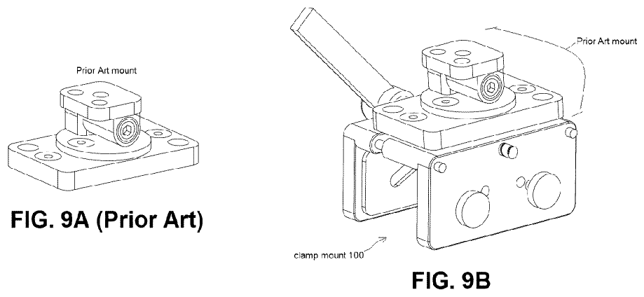

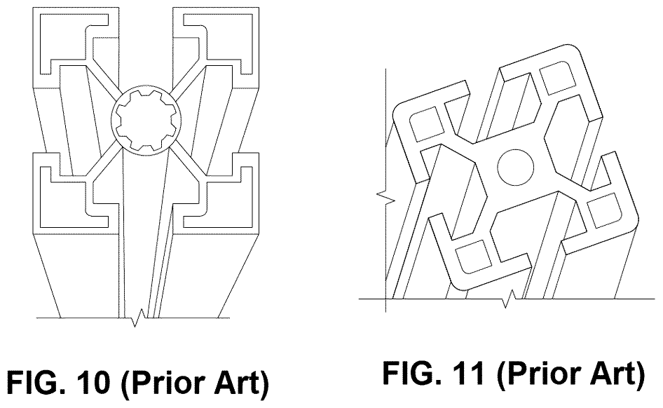

Using the embodiments herein, a customer can apply many types of existing Prior Art mounting hardware (AKA mounts) to the mounting surface 180 that previously could not attach to T-slot rail in any way. Example prior art mounts are shown in FIGS. 9A and 13, and FIG. 14 shows a Prior Art mount attached to the mounting surface 180.

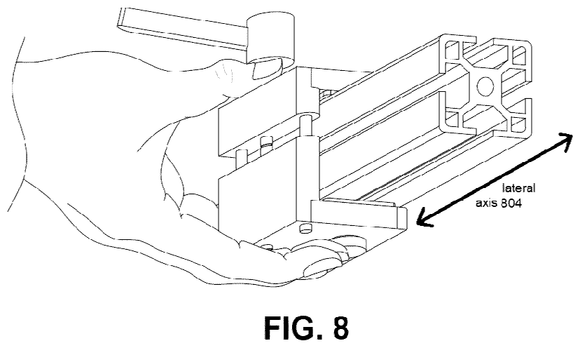

An example lateral axis 804 of T-slot rail is shown in FIG. 8. In an embodiment, the threaded pins 120 can be entirely discarded, as they are not captive within the mated clamping portion 109 big. One example might be where a user desires to slightly un-clamp the clamp-mount 100, and move it along the lateral axis 804 (FIG. 8) of the T-slot. However, the T-slot rail might be partially blocked off. Accordingly, removing the threaded pins 120 might help facilitate lateral movement of the clamp mount 100 along the T-slot rail. Alternately, the threaded pin 120 could be not removed entirely but instead just backed out far enough to be flush with the interior surface of the mated plate 109 big.

### Installation

FIG. 1A shows both a mounting surface 180 and also a sizing surface 184, where both are located in the mated plate 109 big. The two surfaces 180 and 184 are perpendicular to each other, and have different purposes.

During installation, the sizing surface 184 is first used, when someone is first attaching the clamp mount 100 to any T-slot tubing. This requires the installer to know the specific size of the T-slot tubing and then insert the threaded pins 120 accordingly.

After that sizing is set, the user will typically then attach the specific Prior Art mount to the mounting surface 180 (not the sizing surface 184) as shown in FIGS. 9A-9B.

However, this could also be done in the reverse order, where an installer first attaches the Prior Art mount to the clamp mount 100, and then attaches to the T-slot.

### Sizing Surface 184 (Markings 150 and Holes 154)

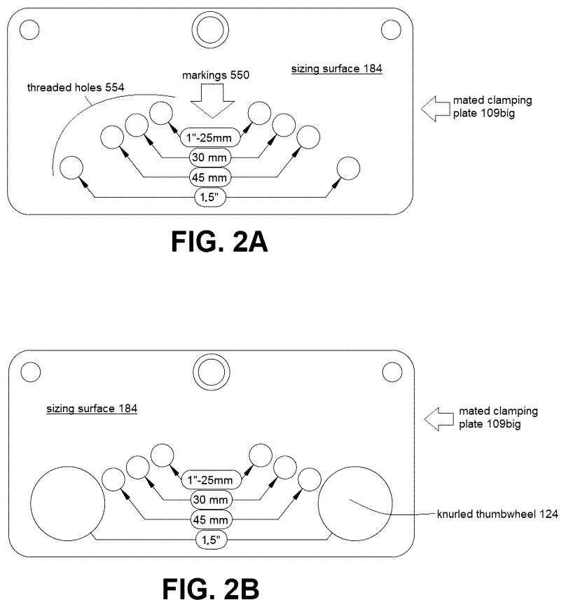

FIGS. 2A-2B shows various size-coordinated threaded (tapped) holes 154 and markings 150 within the sizing surface 184. In FIG. 2A, the sizing surface 184 is unpopulated, while in FIG. 2B, the sizing surface has the threaded pins 120 in a user-chosen position, where the thumbwheels 124 are the visible portion of the pins 120.

The markings 150 indicate which threaded holes 154 are suitable for putting the pins 120 for a particular rail. Thus, if selecting a 30 mm size for the square T-slot rail, the markings 150 direct a user to the second set of holes from the top. A user will then locate the threaded pins 120 into the 30 millimeter hole(s) to help the clamp mount 100 stay in-position while clamped to the T-slot or other mounting surface. One advantage of the multiple size compatibility of the sizing surface 184 is reducing any need for additional mounting products, thus achieving a “one-size-fits-many” effect.

The tapped holes 154 shown in the Figures are for example-only, and thus should not be considered limiting. The tapped holes could be re-situated according to customer-preference, in the event a different size of T-slot is used.

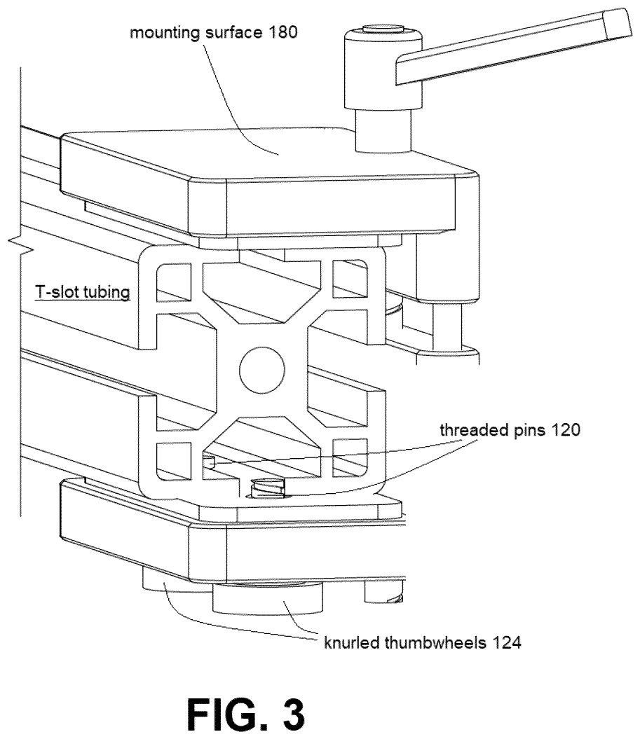

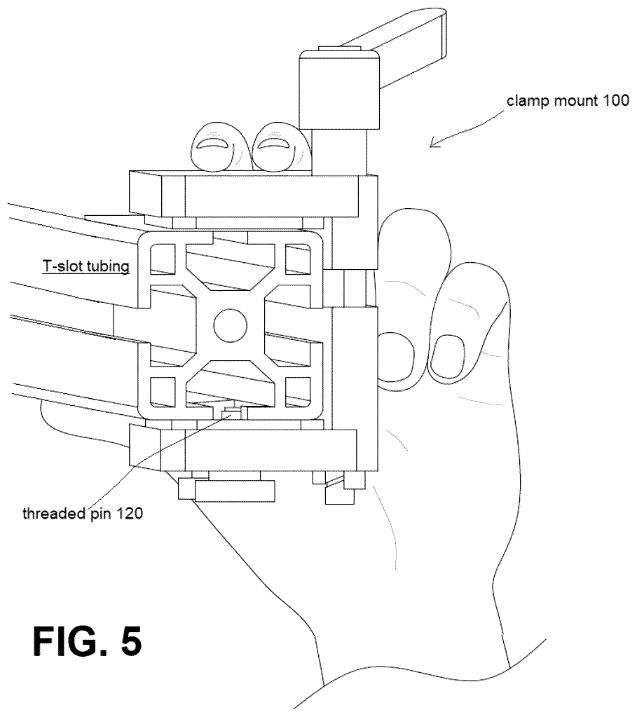

FIGS. 3 and 5 show an example clamping orientation where the threaded pins 120 are free-floating inside the T-slot. The threaded pins 120 are threaded only for a tapped interior (not shown) of the mated clamp plate 109 big but not for the T-slot tubing or other attachment surface. FIGS. 3 and 5 show an example views of the threaded pins 120 not touching the T-slot tubing but still potentially providing support in case of a twist or tension on the clamp mount 100, thereby providing a secondary retention source.

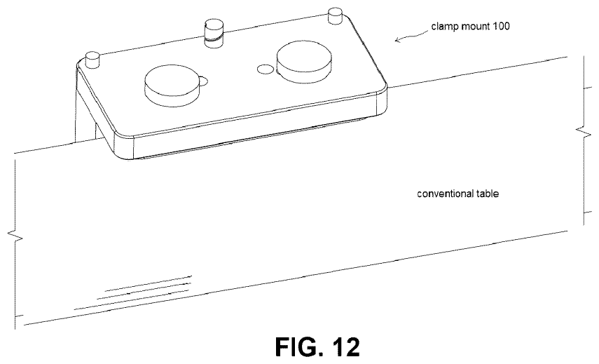

The clamp mount 100 can also be used with non T-slot environments. Some non T-slot mounting surfaces can include table-edges or other flat surfaces, as shown in FIG. 12. The clamp mount 100 can attach to such rectangular surfaces as long as they have a thickness conforming with the gap 748.

The pins 120 are helpful for holding the clamp mount 100 in position on whatever surface. The primary clamping force is the through-bolt 104, which is squeezing the two mated plates 109 big and 109 small, but the pins 120 can provide a supplemental support.

As the through-bolt 104 is tightened, the rubber pads 128 squeeze inward until the clamp mount 100 is fixedly attached. An embodiment can have non-stick material on both mated plates 109 big and 109 small.

### Commercial Usages

It may be desired to have a vision system clamp onto available existing T-slot structures but without having to take anything apart. One specific application is for a large retail manufacturer having a “scanning base” for scanning checkout items. Using the embodiments herein, such arrangements install cameras on the Prior Art mounts and clamp on the clamp mount 100 using minimal labor time.

A scanning base can be a very high traffic thus cash-rich area. Accordingly, such a manufacturer pays a lot of money per hour to operate such an area, so minimizing its downtime is critical. Using the embodiments herein, a user can install the clamp mount 100 quickly, and not have to reassemble the T-slots afterwards thereby saving time. In such a case, any cost of the clamp mount 100 is still significantly less than the expense of complex takedown and re-assembly.

Further advantages of the clamp mount 100 include being self-contained, accommodating most existing mount hardware, and will adapt to at least four different size pieces of rail (see FIGS. 2A-2B).

### Dimensions, Fit, and Usage

FIG. 1A shows the clamp portion 108 having a gap 768. The clamp portion 108 can only expand so far and can only clamp so far. In an embodiment, a potential maximum gap 768 that the clamp can do might be 1.75″ and a minimum gap 768 might be 1.0″. That leaves a fair bit of adjustability, plus add on a smush (compression) factor of the rubber pads 128. Some dimensions of gap 768 may be lost as tightening occurs.

It is also possible to not use the threaded pins 120 at all, where a user can just clamp (apply) the clamp mount 100 directly onto the T-slot or rail. The threaded pins 120 can act as a type of additional mechanical security measure, but there are certainly configurations in which the force of the through bolt 104 is sufficient to grippingly retain the clamp mount 100.

As shown within numerous Figures herein, the mounting surface 180 has a limited amount of real estate for making tapped holes 704 for attaching mounts. Further, these tapped holes 704 must not interfere with the through-bolt 104 or the threaded pins 120. This results in a slight constraint on real estate usable for tapping holes suitable for mounts.

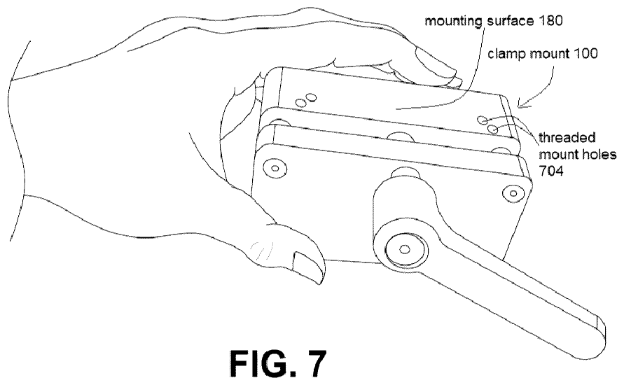

The mounting surface 180 is user-configurable and user-adjustable herein could accommodate a variety of hole-patterns, thereby increasing the utility and flexibility. One example pattern of threaded mount holes 704 is shown in FIG. 7. A variety of hole-interfaces make suitable patterns for a Prior Art attachment mechanisms (mounts). A key factor for the clamp mount 100 is to achieve a one-size-fits-many effect.

FIG. 9A shows an example Prior Art mount or attachment mechanism, which could normally not attach to T-slot tubing. The embodiments herein resolve this as shown in FIG. 9B, which shows that same Prior Art mount being accommodated by the clamp mount 100.

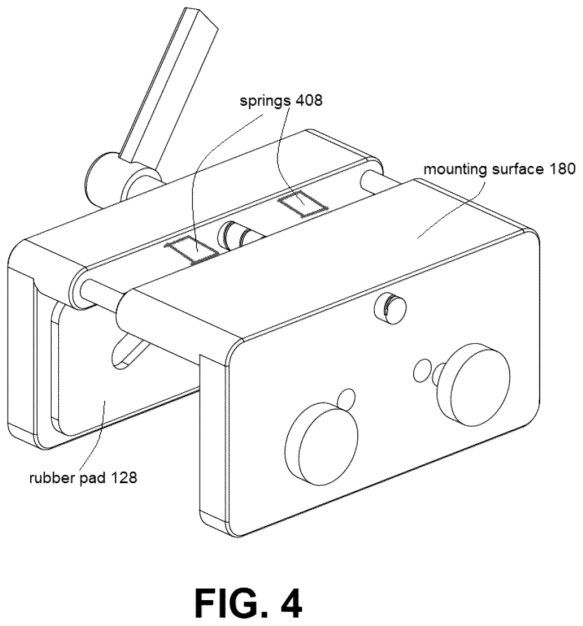

The clamp mount 100 is designed to hold its position well, and yet still be moved often. Accordingly, an embodiment includes one or more spring(s) 408 as shown in FIG. 4 to assist in movement. Without any spring, when a user goes to un-clamp (remove) the clamp-mount 100, it would stay more or less together until that user manually pulls it apart. This may require two hands, but the user may be hand-constrained. Depending on how often the user moves or adjusts the clamp-mount 100, the spring(s) 408 might make it easier for a user to make adjustments.

The through-bolt 104 would be in permanent opposition to any such spring 408. This way, a spring 408 would automatically open up the gap 768 as one opens the clamp mount 100.

The clamp-mount 100 can be composed of aluminum 6,000 series or upwards, e.g. type two. The aluminum can be anodized.

The handle 112 can “index” (verb), meaning being movable without changing any tension\adjustment on the clamp-mount 100. So when tightening the clamp portion 108, it may be desired to avoid the handle 112 sticking out in free space. Even after the handle 112 is tightened, one can reposition the handle 112 or re-index it without losing any tension on the through-bolts 104. This is helpful for environments in which a protruding handle could be jostled or touched, or in the way of a path from other moving parts within the industrial configuration/arrangement.

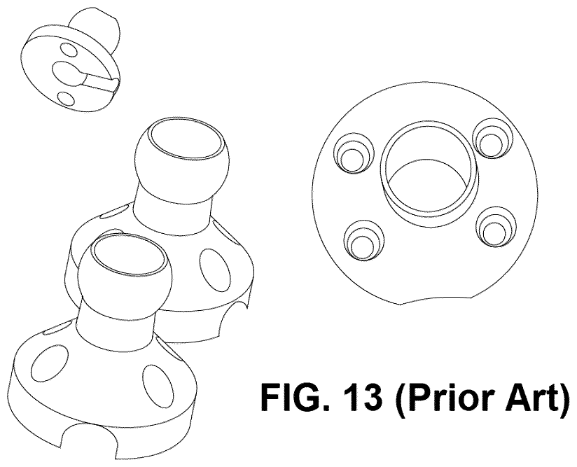

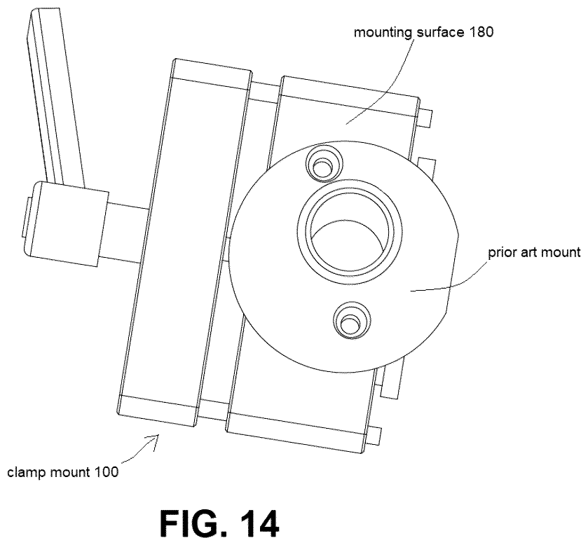

As shown in FIGS. 9A-9B, some Prior Art mounts may require four threaded mount holes 704 within the mounting surface 180. However, as shown in FIGS. 13-14, a typical industrial arrangement may only need two threaded mount holes 704 to be effective.

### Through Pins 120

The through pins 120 have threads, but these threads 120 mate only to the tapped interior of the mated clamp plate 109 big and are not mated to anything within the T-slot tubing. It is possible to back out the threaded pins 120 to just be flush, and then they wouldn't protrude. Although that's not an first choice usage, there exist customers that might need this.

### Disclaimer

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method of manufacturing and configuring a customized clamp for attaching a mount, comprising:
configuring a clamp portion to comprise two mated clamping plates plate-big and plate-small;
configuring the two mated clamping plates to bidirectionally move along a clamping axis;
adapting the clamp portion to open and close along the clamping axis; and
positioning a through bolt for facilitating movement of the two mated clamping plates along the clamping axis.

2. The method of claim 1, further comprising:
locating a mounting surface within the plate-big; and
locating a sizing a surface within the plate-big.

3. The method of claim 2, further comprising:
positioning the sizing surface to be perpendicular to the mounting surface.

4. The method of claim 3, further comprising:
locating matching rubber pads on respective interior portions of the two mated clamping plates to be suitable for gripping onto a section of T-slot tubing.

5. The method of claim 3, further comprising:
the sizing surface containing two or more threaded apertures for accommodating two or more threaded pins;
configuring the threaded pins with knurled thumbwheels operatable by a user; and
configuring the sizing surface to have user-selectable threaded holes; and
locating markings near the threaded holes to assist a user in making a selection of a specific type of T-slot tubing.

6. The method of claim 5, further comprising:
the markings indicating which threaded holes are suitable for putting the threaded pins into a particular size of T-slot tubing.

7. The method of claim 5, further comprising:
configuring the mounting surface with a plurality of threaded mounting holes prior to shipping to a customer.

8. The method of claim 5, further comprising:
shipping to a customer with the mounting surface unaltered for letting the customer self-configuring the mounting surface to have a plurality of threaded mounting holes.

9. The method of claim 6, further comprising:
a user locating the threaded pins into the pre-configured tapped holes to help the clamp mount stay in-position while clamped to the T-slot tubing; and
arranging the tapped holes to have varying positions depending on a size of T-slot tubing.

10. The method of claim 4, further comprising:
configuring the clamp mount for attaching to a tabletop.

11. The method of claim 2, further comprising:
the through bolt providing a primary clamping force for squeezing the two mated plates plate-big and plate-small.

12. The method of claim 9, further comprising:
configuring the clamping portion so that as the through bolt is tightened, the rubber pads squeeze inward until the clamp mount is fixedly attached to the intended surface.

13. The method of claim 12, further comprising:
configuring the threaded pins to be optional; and
applying the clamp mount directly onto a surface without any threaded pins.

14. The method of claim 6, further comprising:
configuring the mounting surface such that any tapped holes located therein avoid a travel path of the through-bolt.

15. The method of claim 6, further comprising:
configuring the mounting surface such that any tapped holes located therein avoid a travel path of the threaded pins.

16. The method of claim 2, further comprising:
one or more springs assisting in movement of the mated plates along the clamping axis.

17. The method of claim 1, further comprising:
configuring the handle to index and be movable without changing any tension\adjustment on the clamp mount; and
after the clamp portion is tightened, facilitating repositioning of the handle without losing any tension on the through bolt.

18. The method of claim 6, further comprising:
the threaded pins acting as a secondary retention source.

19. The method of claim 6, further comprising:
configuring the clamp mount to accommodate T-slot tubing having varying sizes; and
configuring the sizing surface for at least four different size pieces of T-slot tubing.

20. The method of claim 19, further comprising:
positioning the threaded pins through two or more tapped holes located at predetermined locations in the sizing surface thereby matching with one of a plurality of sizes of T-slot tubing.
